(19) United States
(12) Patent Application Publication
(10) Pub. No.: US 2009/0016720 A1
(43) Pub. Date: Jan. 15, 2009

(54) Problem detection device at ONU end in PON system and method thereof

(75) Inventor: Kevin Lu, Taipei (TW)

Correspondence Address: BACON & THOMAS, PLLC, 625 SLATERS LANE, FOURTH FLOOR, ALEXANDRIA, VA, 22314-1176, US

(73) Assignee: Inventec Multimedia & Telecom (Tianjin) Co., Ltd., Tianjin (CN)

(21) Appl. No.: 11/822,901

(22) Filed: Jul. 11, 2007

(51) Int. Cl. H04B 10/20; H04J 14/00

(52) U.S. Cl. 398/63

(57) ABSTRACT

A problem detection device at an optical network unit (ONU) end in a passive optical network (PON) system and a method thereof are provided, which aim at solving the problem that the user cannot check out photo-physical data on the physical architecture, logical signal information on the logical architecture, and parameter information on the network communication protocol of the PON system economically, quickly, and accurately, once a connection error occurs at the ONU end. The technical lies in using an optical network signal to pass through the integrated optical path analysis module, the ONU module, and the network communication protocol message analysis module included in the problem detection device to achieve the detection and analysis of the problem of the ONU connection error at one time once the problem detection device is connected to the PON system.

### BACKGROUND OF THE INVENTION

1. Field of the Invention

The present invention relates to a problem detection device of a network system. More particularly, the present invention relates to a problem detection device at an optical network unit (ONU) end of a PON system.

2. Related Art

Currently, as the population of using Internet to transmit/receive data is dramatically increased, a great number of messages are transmitted over network. As the number of the subscribers gradually increases, more and more commercial platforms and services are constructed over Internet, and thus, the application scope of communication and data network becomes more and more complicated. However, as the utilization and complexity of the network are both increased, more and more problems are correspondingly derived there-from.

In order to cater to the increasingly large demand for the network, the network service suppliers have proposed many different network transmission architectures, in which the PON system in the optical communication field has become the most rapidly developed network transmission architecture recently. Since invisible light is used for transmission, how to make clearly about the physical state problem of the optical network signal or the logical communication problem on the connections between the ONU and the PON system, or even how to ensure the communication network to be normal, is a difficult and tough job.

Generally, the problems are detected in the central office (CO) by using equipments worth tens of thousands of dollars. As the concept of triple play emerges, Fiber To The Home (FTTH) begins to make sense, such that the fiber will be connected into every home in the future, and the previous problem detection method becomes unfeasible, that is because it is impossible for every line examiner to carry the equipments worth tens of thousands of dollars to each home to detect problems. Moreover, since the problems to be detected have different reasons, the required problem detection devices are also different, thus the conventional problem detection method has defects in application.

In addition, taking the process of detecting problems in a PON system as an example, which is a mainstream of the current market, most circumstances generated after the problem detection lie in that, the connection error is got to know, but the exact problematic points for the malfunction cannot be found out and must be acknowledged by experts through subjective determination. However, as the professional degree varies from person to person, the determining result is also different. Moreover, the problem-detection relevant technique in the conventional art aims at detecting problems at a single aspect, such as the physical architecture problems on the PON system. However, although the hardware equipment can operate normally under most circumstances, the messages for being transmitted still cannot be definitely transmitted to the correct ONU end, that is, the problems on the logical signal and on the network communication protocol should also be taken into account, and even other problems may exist to be detected.

Therefore, under the precondition of considering the economic benefits, an integrated tool is needed to assist the problem detection, such that the users without too much knowledge background about optical physics and the communication logical knowledge can still find out the problem and obtain suggestions quickly and correctly with the assistant of the tool, so as to achieve the efficacy of easily evaluating the incorrect messages at a low cost, a high efficiency, and a high accuracy, and thus, it is believed that, after entering the era of optical fiber communications, the guarantee of the network quality is no longer a complicated task.

### SUMMARY OF THE INVENTION

In view of the situation of the current PON system that users' problem-detection issue at an ONU end cannot be effectively solved in the prior art, the present invention is directed to a problem detection device at an ONU end of a PON system for solving the users' problem-detection issue in the PON system at one time.

The problem detection device at the ONU end of the PON system disclosed in the present invention includes an output unit, an input interface, an optical path analysis module, an ONU module, a network communication protocol message analysis module, and a central processing unit (CPU), which performs the problem detection through integrating a physical architecture part, a logical signal part, and a network communication protocol message parameter part included in the PON system, so as to achieve the problem detection and automatic analysis for the optical network at one time.

The problem detection method of the problem detection device at the ONU end of the PON system disclosed in the present invention includes an optical path analysis, an ONU connection test, a network communication test, and integrating photo-physical data generated in the optical path analysis, PON logical signal information generated in the ONU connection test, and network communication protocol parameter information generated in the network communication test for being outputted and displayed as a result. The problem detection and automatic analysis of the optical network are achieved through analyzing the physical architecture part, the logical signal part, and the network communication protocol message parameter included in the PON system.

Compared with the prior art that the problem detection issue can only be performed by using expensive equipments at the central office, and merely directed to a single aspect of problems, and the detecting personnel are required to be well educated and received further education in order to be capable of determining the problems of the optical network, the present invention achieves the efficacy of easily evaluating incorrect messages at a low cost, a high efficiency, a high accuracy, and solving the problem analysis and detection issue for the optical network at one time.

The features and practice of the present invention are illustrated below in great detail with reference to the accompanying drawings.

### BRIEF DESCRIPTION OF THE DRAWINGS

FIG. 1 is a schematic view of a basic architecture of a conventional PON system.

FIG. 2 is a schematic view of a data transmission process of the conventional PON system.

FIG. 3 is a block diagram of a problem detection device according to the present invention.

FIG. 4 is a flow chart of a problem detection method according to the present invention.

FIG. 5 shows an embodiment of the problem detection device according to the present invention.

### DETAILED DESCRIPTION OF THE INVENTION

A PON system is a point-to-multipoint optical network architecture, an optical line terminal (OLT) at the central office is connected with ONU at multiple customer premises through a passive element, e.g., an optical splitter, and the ONU is responsible for receiving and sending signals or further processing the signals. Generally, there are four basic statuses when establishing connections with the ONU: no connection, normal connection, connecting, and connection error, and the present invention mainly directs to the technical content on how to detect problems involved in the connection error once the connection error occurs.

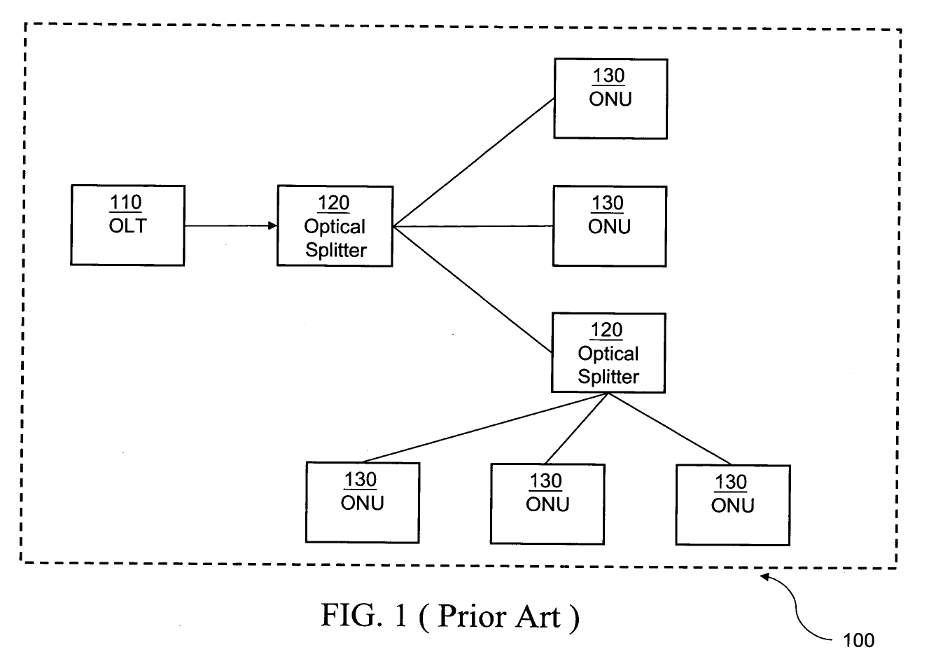

As shown in FIG. 1, a schematic view of a conventional architecture of a PON system 100 is disclosed, in which the central office equipment is an OLT 110 mounted in a central office (CO). The OLT 110 is connected to a passive optical splitter 120 through a section of a single-mode fiber, and then divided into 16, 32, or 64 branches in maximum for being connected to the ONU 130 of each customer premise respectively, or connected to another optical splitter 120 for being further divided into more branches and then connected to the ONU 130. The ONU 130 is also referred to as an optical network terminal (ONT), which is responsible for transmitting/receiving signals or further processing the signals.

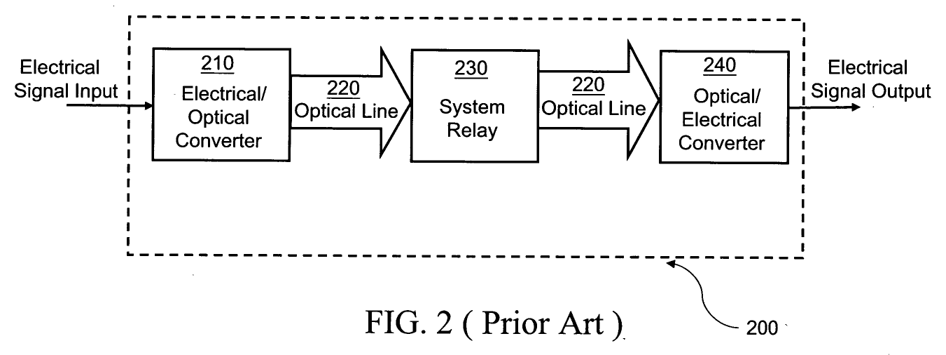

Basically, the PON system 100 takes light as a transmission signal, takes an optical fiber as a transmission medium, converts the inputted electrical signal into an optical signal, and achieves the data transmission by utilizing various optical characteristics. The schematic view of the basic data transmission process is shown in FIG. 2. First, an electrical signal is input through a terminal equipment such as a television, a telephone, a fax machine, a computer, etc. Next, the electrical signal is converted into an optical network signal carrying a transmission message after passing through an electrical/optical converter (EOC) 210 (such as a laser or an LED). Then, the optical network signal is inputted into an optical line 220, and then passes through a system relay 230 with functions of amplifying the optical power and shaping the optical waveforms. Then, the optical network signal is outputted from the rear end of the optical line 220, and converted into an electrical signal after passing through an optical/electrical converter (OEC) 240, and then connected to the terminal equipment for being outputted. The wavelengths used in the PON system are respectively a down link wavelength 1490 nm transmitted from the OLT to the ONU, and an up link wavelength 1310 nm transmitted from the ONU to the OLT.

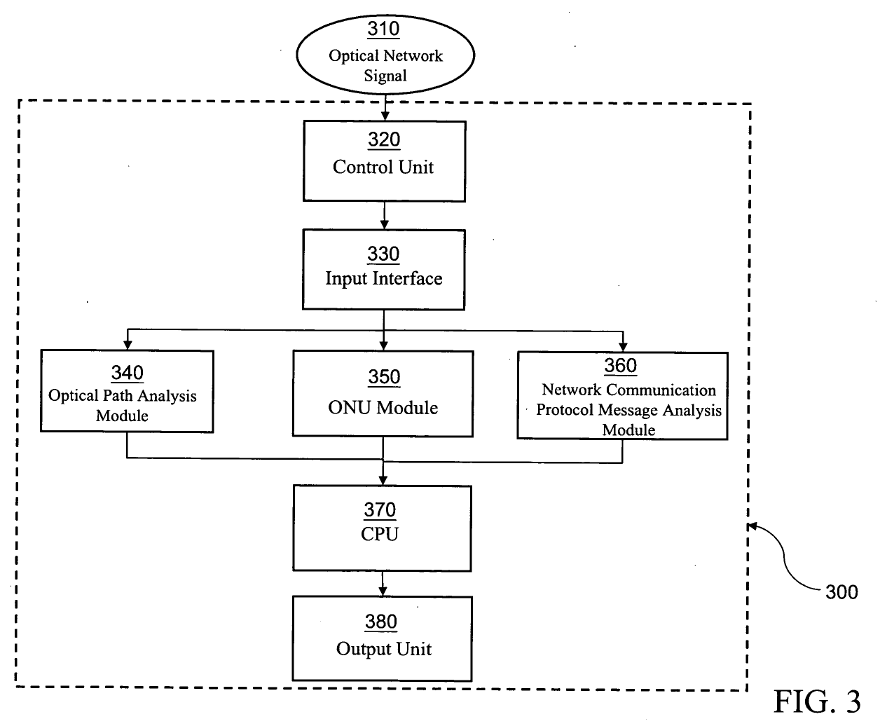

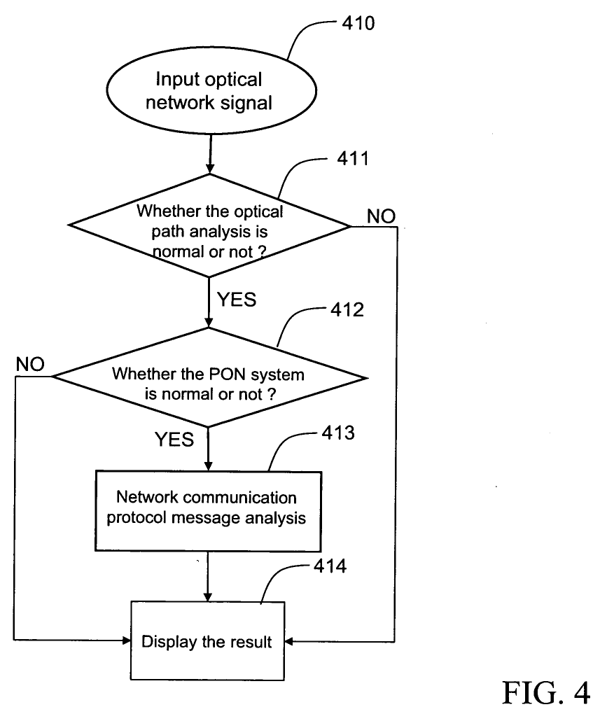

In the current detection technique, expensive equipment is generally required to be used in the central office, which is merely directed to detecting a single aspect of problems, and needs subjective determination by experts. As a result, the above current detection technique has a high cost, a low efficiency, and the connection error on the PON system cannot be detected conveniently and quickly. Therefore, the present invention provides a problem detection device at an ONU end in a PON system and a method thereof, which can be applied in detecting problems for all PON systems, including an asynchronous transfer mode (ATM)-based passive optical network architecture (ATM PON, APON) system, a broadband PON (BPON) system, a Gigabit/Ethernet PON (G/EPON) system, and an Ethernet PON (EPON) system. FIG. 3 and FIG. 4 are respectively a block diagram of a problem detection device at an ONU end of a PON system of the present invention and a flow chart of a problem detection method according to the present invention, which are illustrated together hereinafter.

When an input interface 330 of the problem detection device 300 of the present invention is connected to an optical network signal 310 on the PON system to be detected, it receives the inputted optical network signal once being taken as an ONU end (Step 410). A control unit 320 is used by the user for setting at least one physical detection, a connection test program, and at least one network communication protocol detection for the current problem detection mode, and meanwhile, the problem detection for the PON system is enabled. In the following embodiment, the problem detection device 300 is designed to detect problems though three phases, namely, an optical path analysis phase, an ONU connection test phase, and a network communication test phase, every phase is communicating to each other. The problem detection process can be performed simultaneously or in a specific sequence, which is not limited in the present invention, and it is illustrated below in detail with reference to FIG. 3 and FIG. 4.

After Step 410, the optical network signal 310 is detected through the optical path analysis module 340, which can selected form a group consisting of an optical transceiver unit, an optical power meter, and an optical wavelength scanner for performing optical path analysis in Step 411, by using at least one physical detection means to detect the optical network signal, so as to obtain at least one corresponding photo-physical data, in which if the optical network signal 310 is detected to be an abnormal optical network signal, it further determines in Step 411 whether the optical loop architecture has a malfunction or not, for example, whether it lacks of an optical power for transmitting/receiving, whether there is a jam for the optical network signal, whether there is too much optical interference, or whether an error occurs to the optical splitter in the optical loop or not. After obtaining the reasons to the problem, the results are transmitted to the CPU 370, and then, they are integrated and outputted to the output unit 380 in Step 414.

If the optical network signal 310 is detected to operate normally in Step 411, the optical network signal 310 to be detected is transmitted to the ONU module 350. Then, in Step 412, it is detected whether an error occurs to the PON system or not by simulating a connection test program at the ONU end, so as to obtain at least one PON logical signal information in the optical network signal 310, such as whether an error occurs to the encoding/decoding IC at the ONU end, or whether the message transmission can be normally hand-shaken or not. If an error occurring to the PON system is detected here, a piece of PON logical signal information is generated and transmitted to the CPU 370, and then integrated and outputted to the output unit 380 in Step 414.

If it is determined that no error occurs to the PON system, the optical network signal 310 to be detected is transmitted to the network communication protocol message analysis module 360 for performing the network communication test. For executing at least one network communication protocol detection to detect the optical network signal, so as to obtain at least one corresponding network communication protocol parameter information in Step 413, the network communication protocol parameter information contained in the optical network signal 310 is evaluated, so as to detect whether the optical network signal 310 is transmitted normally based on the network communication protocol of the PON system architecture. The network communication protocol message analysis module 360 can be an Ethernet-based transmission control protocol/Internet protocol (TCP/IP) module, and a Multi-Protocol Over ATM (MPOA) module, and can analyzing the protocol which includes a 802.3ah network communication protocol, an Ethernet network communication protocol, an ATM network communication protocol, and a PPPoE, etc. Finally, the determining result is transmitted to the CPU 370, and integrated and outputted to the output unit 380 in Step 414.

The output unit 380 mentioned above, is for displaying messages that processed by CPU 370, it can be a liquid crystal display (LCD), a touch panel, or a cathode-ray tube (CRT).

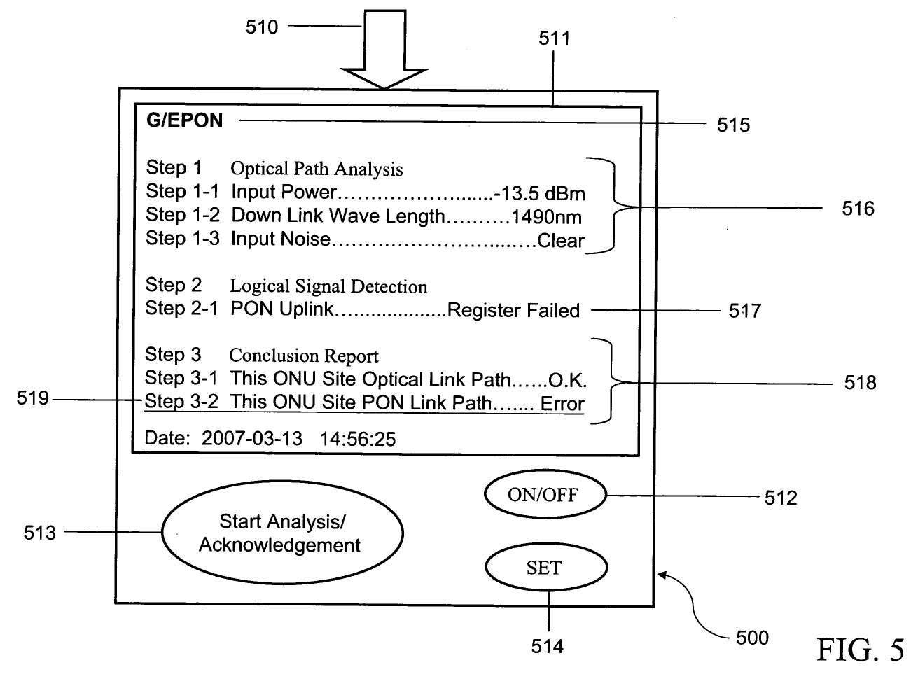

FIG. 5 shows an embodiment of the present invention, which takes the problem detection at an ONU end of a Gigabit/Ethernet PON (G/EPON) system as an example for illustration. 500 indicates a schematic view of the problem detection device of the present invention, in which an input end is connected to an optical network signal source line 510 to be detected, and the problem detection device performs the problem detection and analysis for the inputted optical network signal, and displays the detection result on the LCD 511. As shown in FIG. 5, after the ON/OFF button 512 of the device is pressed down to turn on the power, the optical network signal source line 510 is connected to the problem detection device. The SET button 514 is used to select the current PON system mode to be detected. The message 515 of G/EPON shows that the user now selects to detect problems at the ONU end of the G/EPON system. Then, the button of Start Analysis/Acknowledgement 513 is then pressed down to start detecting problems for the inputted optical network signal.

In Step 411, after the optical path analysis is finished, the detection result is displayed in the message 516. The message 516 includes informing the user that the first step of the problem detection is an optical path analysis, and displaying various analysis data. After Step 411, the signal to be detected is acknowledged to be a normal optical network signal, and then enters to Step 412.

In Step 412, an ONU connection test is performed on the PON system, and the detection result is displayed on the LCD 511. The message 517 is a piece of PON logical signal information generated in Step 412, which shows that the abnormal handshake on the PON system causes the register failed.

After the reasons to the problem have been found, a conclusion report 518 is generated to inform the user about the result of the problem detection. The message 519 shows the reasons to the problem analyzed in the problem detection process. After the detection, the button of Start Analysis/Acknowledgement 513 is pressed down, such that the problem detection device stops the analysis.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A problem detection device at an ONU end in a PON system, applicable for being connected to the PON system for detecting problems for the PON system, comprising:
an output unit;
an input interface, connected to an optical network signal from the PON system;
an optical path analysis module, connected to the input interface, for using at least one physical detection means to detect the optical network signal, so as to obtain at least one corresponding photo-physical data;
an ONU module, connected to the input interface, for simulating a connection test program at the ONU end in the PON system, so as to obtain at least one PON logical signal information in the optical network signal;
a network communication protocol message analysis module, connected to the input interface, for executing at least one network communication protocol detection means to detect the optical network signal, so as to obtain at least one corresponding network communication protocol parameter information; and
a central processing unit (CPU), connected to the optical path analysis module, the ONU module, and the network communication protocol message analysis module, for receiving and integrating the at least one photo-physical data, the at least one logical signal information, and at least one network communication protocol parameter information for being outputted to the output unit and displayed as a result.

2. The problem detection device at the ONU end in the PON system as claimed in claim 1, wherein the output unit is selected from a group consisting of liquid crystal display (LCD), touch panel, and cathode-ray tube (CRT) for outputting.

3. The problem detection device at the ONU end in the PON system as claimed in claim 1, wherein the problem detection device further comprises a control unit for selectively setting a problem detection mode constituted by the at least one physical detection means, the connection test program, and the at least one network communication protocol detection means.

4. The problem detection device at the ONU end in the PON system as claimed in claim 1, wherein the optical path analysis module is selected form a group consisting of an optical transceiver unit, an optical power meter, and an optical wavelength scanner for performing optical path analysis.

5. The problem detection device at the ONU end in the PON system as claimed in claim 4, wherein the at least one photo-physical data analyzed by the optical path analysis module is selected from a group consisting of an optical power transceiving data, an optical wavelength scanning data, and an optical interference data.

6. The problem detection device at the ONU end in the PON system as claimed in claim 1, wherein the ONU module is selected from a group consisting of an asynchronous transfer mode (ATM)-based passive optical network architecture (ATM PON, APON) module, a broadband PON (BPON) module, a Gigabit/Ethernet PON (G/EPON) module, and an Ethernet PON (EPON) module.

7. The problem detection device at the ONU end in the PON system as claimed in claim 1, wherein the network communication protocol message analysis module is selected from a group consisting of an Ethernet-based transmission control protocol/Internet protocol (TCP/IP) module, and a Multi-Protocol Over ATM (MPOA) module.

8. A problem detection method at an ONU end in a PON system, applicable for detecting problems for the PON system by connecting a problem detection device to the PON system, comprising:
receiving an optical network signal from the PON system;
using at least one physical detection means to detect the optical network signal, so as to obtain at least one corresponding photo-physical data;
simulating a connection test program at the ONU end in the PON system, so as to obtain at least one PON logical signal information in the optical network signal;
executing at least one network communication protocol detection means to detect the optical network signal, so as to obtain at least one corresponding network communication protocol parameter information; and
receiving and integrating the at least one photo-physical data, the at least one logical signal information, and the at least one network communication protocol parameter information for being outputted and displayed as a result.

9. The problem detection method at the ONU end in the PON system as claimed in claim 8, wherein the obtained at least one photo-physical data is selected from a group consisting of an optical power transceiving data, an optical wavelength scanning data, and an optical interference data.

10. The problem detection method at the ONU end in the PON system as claimed in claim 8, wherein the at least one PON logical signal information in the optical network signal is obtained by one selected from a group consisting of an asynchronous transfer mode (ATM)-based passive optical network architecture (ATM PON, APON) module, a broadband PON (BPON) module, a Gigabit/Ethernet PON (G/EPON) module, and an Ethernet PON (EPON) module.

11. The problem detection method at the ONU end in the PON system as claimed in claim 8, wherein the obtained at least one network communication protocol parameter information is selected from a group consisting of a 802.3ah network communication protocol parameter information, an Ethernet network communication protocol parameter information, an ATM network communication protocol parameter information, and a point-to-point protocol over Ethernet (PPPOE) network communication protocol parameter information.
